(19) United States
(12) Patent Application Publication
(10) Pub. No.: US 2015/0099575 A1
(43) Pub. Date: Apr. 9, 2015

(54) SYSTEMS AND METHODS FOR ENHANCING A BONUS ROUND OF A GAME

(71) Applicant: Gamesys Ltd., London (GB)

(72) Inventors: Hans Elias, Hertfordshire (GB); Thomas David James Aicken, London (GB); Marlon James Dublin, Ilford (GB); Alexander Sandford Todd Young, London (GB); Paul Jacobson, Surrey (GB); David Richard Nulty, Oxford (GB)

(21) Appl. No.: 14/505,489

(22) Filed: Oct. 2, 2014

Related U.S. Application Data
(60) Provisional application No. 61/886,170, filed on Oct. 3, 2013.

(51) Int. Cl. G07F 17/32

(52) U.S. Cl. CPC G07F 17/3262
USPC 463/25

(57) ABSTRACT

In at least one embodiment, systems provide for modifying a bonus round of a wagering game by (i) storing, in association with a player, a plurality of game elements acquired by the player during play of at least one game of a plurality of qualifying games, each such game element corresponding to a respective functionality which causes a modification of a bonus round to which it is applied; and (ii) upon receiving a request to apply one of the game elements in a current bonus round, modifying the current bonus round in accordance with the functionality corresponding to the requested game element. In one embodiment, the applied game element had been acquired by the player in a first game and is applied in a second game.

### CLAIM OF PRIORITY

This application claims the benefit of U.S. Provisional Application No. 61/886,170 filed Oct. 3, 2013 in the name of Elias et al., SYSTEMS AND METHODS FOR A GAME WHICH AUGMENTS BONUS PICK OPTIONS OF A BONUS ROUND. The entirety of this Provisional Application is incorporated by reference herein for all purposes.

### FIELD OF THE INVENTION

### BRIEF DESCRIPTION OF THE DRAWINGS

While the invention(s) described herein are susceptible to various modifications and alternative forms, specific embodiments have been shown by way of example in the drawings and will be described in detail herein, it should be understood, however, that the embodiments are not intended to be limited to the particular forms disclosed. Rather, the description provided herein is to cover all modifications, equivalents, and alternatives falling within the spirit and scope of the invention(s) described.

FIG. 1 is a schematic diagram of an embodiment of a gaming system in accordance with one or more embodiments described herein.

FIG. 2 is a schematic diagram of an embodiment of a gaming platform in accordance with one or more embodiments described herein.

FIG. 3 is a block diagram of an embodiment of a computing device useful in a system according to one or more embodiments described herein.

FIGS. 4A and 4B each illustrate respective example embodiments of a primary game interface for a primary aspect of a game in which a player may acquire a bonus round enhancer.

FIG. 5 illustrates one example embodiment of a game interface (e.g., a screen shot of an online game) for outputting information about available games in which at least one bonus round enhancer may be applied.

FIG. 6 is a flowchart of an example process consistent with one or more embodiments described herein.

### DETAIL DESCRIPTION OF SOME EMBODIMENTS

Games, whether wagering or non-wagering, are a popular past-time for millions of people all over the world. Electronic games in particular are becoming more and more popular, particularly ones playable online using a computer connected to a network. For example, according to some reports more than 200 million people play social games every month and online games recently passed e-mail as the second-most popular activity online, second only behind social networking. Accordingly, there is a need to continue to create exciting electronic games which maintain players' interest and stand out from the multitude of available online or other electronic games (e.g., games embodied in software and playable on a player device).

In accordance with at least some embodiments, a system provides for making available for play a plurality of games, which games comprise both a primary game (also referred to as a first aspect of the game) and a bonus round (also referred to as a bonus game or secondary aspect of the game). In accordance with some embodiments, special elements which may be utilized to enhance a bonus round may be won, earned, purchased, selected or otherwise acquired during play of a primary aspect of at least one first game. Such special elements may be “banked” or saved for a player (e.g., in association with a player identifier). In accordance with some embodiments, a player may be allowed to subsequently access and apply to a bonus round (of the same game in which they were acquired or bonus round of another qualifying game) one or more of such special elements previously stored in association with the player. Such a special element may function to modify or enhance an attribute of a bonus round. Elements which function to modify or enhance an attribute of a bonus round are referred to “bonus round enhancers” herein. Generally, a bonus round enhancer may comprise any element (e.g., symbol) the associated function of which is to enhance the enjoyment and/or expectation (whether actual or perceived) of winning a positive result in the bonus round. Various such functions are described herein.

In one embodiment, for example, a bonus round enhancer may function to “undo” a selection of a player selectable element selected by a player in the bonus round. In another example, a bonus round enhancer may function to eliminate a negative or low value player selectable element from a set of player selectable elements (e.g., before the player selects the negative or low value player selectable elements, such that the player's chances of selecting a positive or higher value player selectable element are increased as a result). In another example, a bonus round enhancer may function to override an otherwise undesired result of the bonus round (e.g., to override an “end bonus round” element selected or generated during the bonus round, which would otherwise function to end the bonus round). In yet another example, a bonus round enhancer may function to cause an output to the player of one or more hints, prompts or information which increases the player's chances of winning a larger prize as a result of the bonus round (e.g., a bonus round enhancer may, when utilized by the player, cause a “sneak peek” of hidden picks to be output to the player or a “heat map” which indicates relative values of picks in a grid of hidden picks). Other examples of bonus round enhancers are described herein.

In accordance with some embodiments, a bonus round in which bonus enhancers are usable may comprise a “pick bonus.” As would be understood by one of ordinary skill in the art, a “pick bonus” type of game is one in which a player is provided with a plurality of player selectable elements. A player selectable element available for selection by a player (or which has been selected by a player) may be referred to as a “pick.” In some types of pick bonus types of games, a characteristic of the player selectable element available in the game is initially hidden or concealed from the player when the player selectable elements are first output to the player for selection. For example, in embodiments in which each player selectable element represents a monetary value or other prize, such monetary value or other prize may be initially hidden from the player. In another example, if the player selectable elements represent respective answers to a riddle, trivia question or other inquiry, the answers represented by the player selectable elements may be initially hidden from the player. In some pick bonus types of games, once a player selects a player selectable element, the characteristic which was previously hidden is revealed to the player (in some embodiments the characteristic may be revealed at the end of the bonus round even for player selectable elements not selected by the player, to show the player the available selections the player did not select). Of course, the embodiments described herein are not limited to use in pick bonus types of bonus rounds. A bonus round enhancer may be utilized in any type or embodiment of a bonus round the enjoyment or probability (whether actual or perceived) of obtaining a winning or positive result may be increased in at least one manner described herein.

Described herein is an innovative system in which a player may win, earn or otherwise acquire different types of bonus round enhancers when playing qualifying games, save such bonus round enhancers for subsequent use and then select which saved bonus round enhancer to use in bonus rounds of different qualifying games. It should be noted that a player may acquire a bonus round enhancer in a first game but then choose to apply or use it in a bonus round of a second, distinct game.

In one embodiment, different types of bonus round enhancers may be associated with different conditions of use (e.g., a particular bonus round enhancer may only be used in certain qualifying games but not in other games in which other types of bonus round enhancers may be used). In one embodiment, a circumstance under which a player acquired a bonus round enhancer may impact one or more conditions of use associated with the bonus round enhancer. Examples of such circumstances which may impact a condition of use to be associated with a bonus round enhancer earned by a player include, without limitation, (i) the game in which the bonus round enhancer was acquired; (ii) whether the bonus round enhancer was acquired during a special time during which bonus round enhancers are allowed more permissive conditions of use; (iii) a recent or average wager placed by the player who acquired the bonus round enhancer; (iv) a status or rating of the player who acquired the bonus round enhancer; and (v) other bonus round enhancers previously acquired by the player.

Additionally, described herein are specific types of bonus round enhancers which provide innovative functionality to a bonus round. For example, one type of bonus round enhancer may function to eliminate all player selectable elements (which have as of yet been unselected by a player in a bonus round) which correspond to a value (e.g., payout amount) which is lower than a value corresponding to a current or most recent player selectable element selected by a player in a bonus round.

In a second example, another type of bonus round enhancer may function to provide an indication of the relative values of player selectable elements whose values are hidden until selected by the player. For example, use of such a bonus round enhancer may cause a kind of “heat map” to be output along with the matrix or other interface comprising the player selectable elements, which is illustrative of the prize values hidden behind the player selectable elements such that the player may determine where the most valuable player selectable elements are located. In one embodiment, such a heat map may be localized to an area around a player selectable element the player is prompted to select.

In yet another example, a bonus round enhancer may function to allow a player to swap, trade in or substitute a most recent player selectable element for another player selectable element. For example, use of such a bonus round enhancer may allow a player to swap, trade in or substitute a most recent player selectable element for (i) a player selectable element in a specified area of the matrix or other interface of a bonus round, such as for one of the player selectable elements which is adjacent to or neighboring the most recently selected player selectable element; (ii) any previously selected player selectable element (e.g., such that the value of the previously selected player selectable element is essentially picked selected twice by the player); (iii) a previously selected and “banked” player selectable element.

In yet another example, a bonus round enhancer may function to automatically select on behalf of the player (or prompt the player to select) the player selectable element corresponding to the highest value of the values yet unselected by the player. In some embodiments, such an automatic selection of the player selectable element corresponding to the highest value may be limited to a particular area of the grid or other interface of the bonus round (e.g., an area defined based on the most recent player selectable element selected by the player). For example, such a type of bonus round enhancer may automatically select for the player (or prompt the player to select) the highest valued player selectable element within a predetermined distance or radius from the player's most recently selected player selectable element.

In yet another example, another type of bonus round enhancer may function to reveal (or select for the player) additional player selectable elements in addition to the player selectable element selected by the player. For example, if a player chooses to use such a bonus round enhancer, then the next player selectable element selected by the player will not only cause the value of that player selected element to be revealed and provided to the player but will further cause a number of additional player selectable elements (e.g., a number of player selectable elements surrounding the initial player selectable element selected by the player) to also be revealed and provided to the player.

In accordance with some embodiments, a player may be allowed to acquire (e.g., win, purchase or earn through skill) different types of bonus round enhancers during play of at least one primary game and bank the acquired bonus round enhancers for use in bonus rounds of at least one qualifying game. In some embodiments, a player may be presented with a menu of qualifying games in which such bonus round enhancers may be acquired and/or utilized.

In accordance with some embodiments, at least some of the games in which bonus round enhancers may be acquired and/or applied comprise a primary aspect of the game which is embodied as a reeled slot machine. Various “reel-type” or reeled slot machine games are popular with many players, whether deployed on dedicated gaming devices (e.g., a traditional slot machine device in a casino, operable primarily to facilitate one or more slot machine games) or on non-dedicated computing devices (e.g., personal computers, mobile devices, laptops or table computers, which are operable to perform a variety of functions in addition to supporting reeled slot machine games). A reeled slot machine game typically includes a plurality of reels, each reel including a plurality of symbol positions for display of a reel symbol. In accordance with some embodiments, the primary aspect of the game may be represented as a reeled slot machine game. However, the invention(s) described herein are not limited to being implemented in a game in which the primary aspect of the game is a reeled slot machine game.

A “symbol” or “game symbol” is a visual representation of an element or indicia used in the game to indicate an outcome or result in the game (e.g., used to indicate at least one of whether the player has qualified for an award, qualified to enter a bonus round, and qualified for an advantage in the bonus round). A reel symbol is a symbol output on a reel of a game interface. The term “symbol” as used herein may refer to a reeled symbol or a symbol of another type of game that is not a reel-type slot machine game (e.g., a game consisting of a grid, such as a bingo game, a representation of a card in a video poker game or any other type of interface that may be applied to embodiments described herein). A reel may be mechanical (e.g., in a physical dedicated gaming device on a casino floor) or virtual (e.g., a software representation of a reel on an electronic display of a dedicated or non-dedicated device, such as an online game playable on a mobile device or PC). In a reel-type slot machine game the reels spin (or representations of virtual reels are made to look as if they spin) after a player places a wager on the game, provides another qualifying input or another reel-initiation event occurs. The reels then stop to display generated combinations of symbols on the reels.

It should be noted that embodiments described herein are not limited to reel-type slot machine games. For example, the embodiments may be implemented in a card game (e.g., a multi-hand video poker game), a grid type game (e.g., a bingo or keno game) or any type of game in which events in a primary game may be utilized to refine player selectable elements available to a player in a bonus round of the game. Thus, it should be noted that although the term “spin” is used to refer to a game event which results in an outcome, the term “spin” is intended to encompass any type of game event (not limited to a game event in a reel-type slot machine game) for which an outcome may be determined.

An “element” of a game, as the term is used herein, is a component, constituent or part of a game which is discernable from another component, constituent or part of the game. In some embodiments, an element of a game may be represented as a symbol or indicia of the game. For example, in accordance with some embodiments a bonus round comprises an interface which includes a plurality of player selectable elements. In one embodiment, each such player selectable element is represented by a respective symbol. In one embodiment, each such player selectable element is associated with a respective value. In one embodiment, at least one such player selectable element is associated with a prize which is provided to the player if the player selects that at least one player selectable element. Another type of element, as described herein, may be a bonus round enhancer, which may comprise a special symbol corresponding to a certain functionality which, when utilized or applied in a bonus round, enhances the bonus round in some manner.

The “outcome” of a spin or other type of game event, as the term is used herein, is the set of symbols as displayed in a set of symbol positions which are evaluated to determine whether the spin results in an award or prize. In a reel-type slot machine game, an outcome of a spin may refer to the symbols displayed along symbol positions comprising one or more paylines of the game. If a generated symbol or combination of symbols is a winning symbol or combination of symbols (i.e., a symbol or combination of symbols associated with an award), the award corresponding to the winning symbol or winning symbol combination is provided or output. The symbols along a payline at the end of a spin (i.e., once the reels are stopped and the symbols in the symbol positions are positioned such that a player may determine whether he/she qualifies for an award as a result of the spin) are referred to as the “outcome of the payline” herein.

In accordance with one or more embodiments, a game (e.g., a game embodied in software and playable on a player device) comprises a primary game and a bonus round. During the bonus round, which may be triggered once a player achieves a qualifying event while playing the primary game, a player is provided with the opportunity to utilize one or more bonus round enhancers which the player has previously acquired (e.g., via play of at least one qualifying primary game, which may be the primary game associated with the current bonus round the player is playing or a different primary game) and banked for subsequent use. In accordance with some embodiments, certain bonus round enhancers may correspond to at least one respective condition of use (e.g., at least one rule for when the particular bonus round enhancer may be used). In accordance with some embodiments, at least one general rule applicable to use of any bonus round enhancer may restrict or govern a player's use of bonus round enhancers in a bonus round (e.g., a player may only utilize on bonus round enhancer in each bonus round event).

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game.

A “casual game”, as the term is used herein unless specified otherwise, may comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein unless specified otherwise, refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data” , as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “session” comprises a period of time spanning a plurality of event instances, game instances, spins or turns of a game, the session having a defined start and defined end. An “event instance”, “game instance”, “session” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game. Accordingly, a session may refer to a session of a primary game or a session of a bonus round, mode or feature of the game, depending on the context.

An “outcome” should be differentiated from a “result” in the present description in that an “outcome” is a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass prizes which may comprise awards, payouts, discounts, eligibility, advancement in a game or other benefits (whether monetary or non-monetary, tangible or intangible) to a player and that any reference to a “prize”, “award” or “payout” may refer to any or all of the foregoing, unless the context explicitly indicates otherwise.

A “bonus round”, “bonus mode” or “bonus feature” of a game, as the terms are used interchangeably herein unless indicated otherwise, may refer to a secondary phase or secondary aspect of a game, entry into which is triggered via one or more events which may occur in a base or primary phase of the game (the base or primary phase of the game is also referred to as the primary game herein). Typically, a player may be able to qualify to play a bonus round based on one or more outcomes in a primary game. A bonus round may be played in accordance with a set of rules that is different from those of a primary game, and may be accompanied by displays, colors, sounds, animated sequences, game play and/or prizes that are not part of the primary game. In one embodiment, a primary or base game application or program may include programming or instructions which will automatically begin a bonus round after the player has achieved a triggering event or qualifying condition in the primary game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features, functionality or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an gaming entity may, for example, comprise various specialized computers that interact to provide for online games as described herein.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

### DESCRIPTION OF FIGURES

### Example Systems

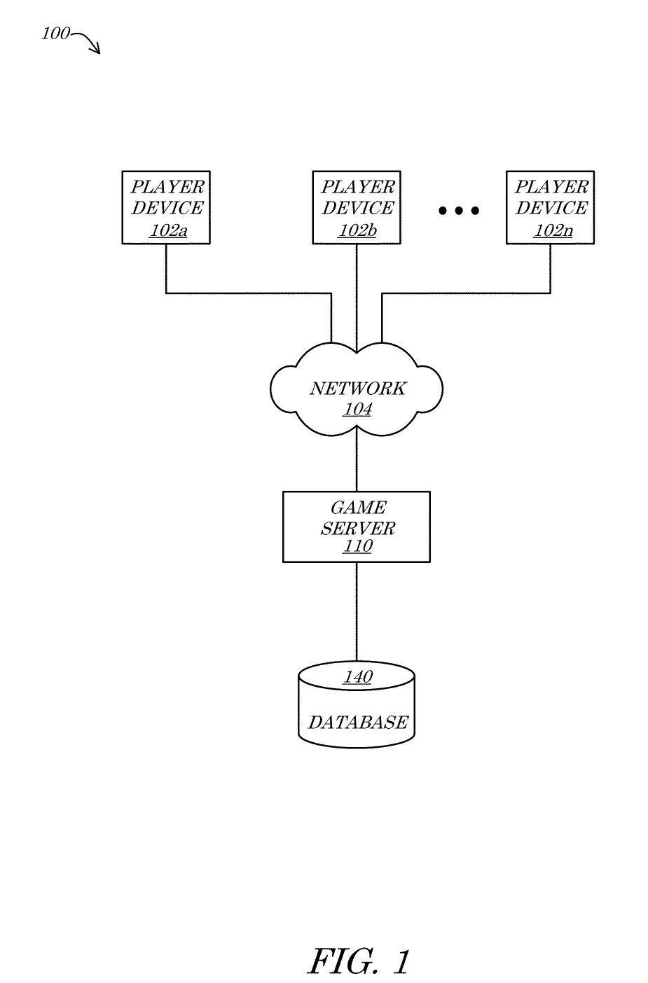

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) for an event instance, spin or turn of a game, (ii) a current state or status of a game or game session (e.g., a number and type of bonus round enhancers collected during play of at least one primary game), (iii) one or more user interfaces for use in a game, (iv) one or more game themes for a game and/or (v) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game. For example, the game server may facilitate a game by (i) receiving an input from a player or player device; (ii) determining an outcome for a primary game; (iii) causing an outcome of a game to be displayed on a player device; (iv) adjusting a number of collected bonus round enhancers of a certain type based on an outcome of a primary game or use of a bonus round enhancer by the player in a bonus round; (v) adjusting a bonus round interface based on a player's election to use a bonus round enhancer in a bonus round; (vi) adjusting a result of a bonus round based on a player's election to use a bonus round enhancer in a bonus round; (vii) outputting information to a player based on the player's election to use a bonus round enhancer in the bonus round; (viii) facilitating a wager and/or facilitating a provision of a payout for a game.

In one embodiment, the game server 110 may comprise a server computer operated by a game provider or another entity (e.g., a social network website not primarily directed at providing games). In some embodiments, the game server may determine an outcome for spin of a game by requesting and receiving such an outcome from another remote server operable to provide such outcomes. In some embodiments, the game server 110 may further be operable to facilitate a game program for a game (e.g., a wagering game).

In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator).

Examples of processes that may be performed by the game server 110 (directly or indirectly) may include, but are not limited to: (i) determining an outcome of a primary game, including determining a number (which may be zero) and/or type of bonus round enhancer(s) to be provided (e.g., in the case of a non-wagering or social game) or won (e.g., in the case of a wagering game) by the player as a result of the outcome of the primary game; (ii) determining whether the outcome causes a bonus round to be initiated; (iii) determining a plurality of player selectable elements to populate a bonus round interface with, which may include determining a value and/or placement for each respective player selectable element; (iv) receiving a player input, such as an indication of which player selectable element(s) the player selected during the bonus round and/or a selection of a bonus round enhancer to be applied to the bonus round; (v) transmitting an indication of an outcome (for a primary game and/or a bonus round) for output on a player device; (vi) authorizing a game program to be downloaded to a player device; and/or (vii) determining a result of a bonus round based on player selections of player selectable elements comprising the bonus round and/or any bonus round enhancers the player has elected to use or apply in the bonus round.

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ Plasystation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102.

A player device 102 may be used to play a wagering or non-wagering game (e.g., a social or casual game) over a network and output information relating to the game to players participating in the game (e.g., outcomes for an event instance of the game, qualifying for a bonus round of the game, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that an event instance (e.g., a new spin or other request for a new outcome) has been triggered or initiated (and, in some embodiments, communicating such a trigger or initiation to game server 110), (ii) a first outcome for a first aspect of the game (e.g., an outcome of the primary game, which may include determining whether the outcome is to include any bonus round enhancers and, in some embodiments, the type of bonus round enhancers to be included and the condition(s) of use, in any, to be associated with such bonus round enhancers); (iii) determining a second outcome for a second aspect of the game (e.g., a plurality of player selectable elements for the bonus round which may be triggered during the primary game); (iv) a result of a spin of the primary game, and/or (iv) a result of a bonus round. In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110.

It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102. In accordance with some embodiments, a player device 102 may optionally communicates with game server 110 such that each player device 102 operates as a “thin client” having relatively less functionality, a “thick client” having relatively more functionality, or with any range of functionality therebetween (e.g., an “intermediate client”).

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

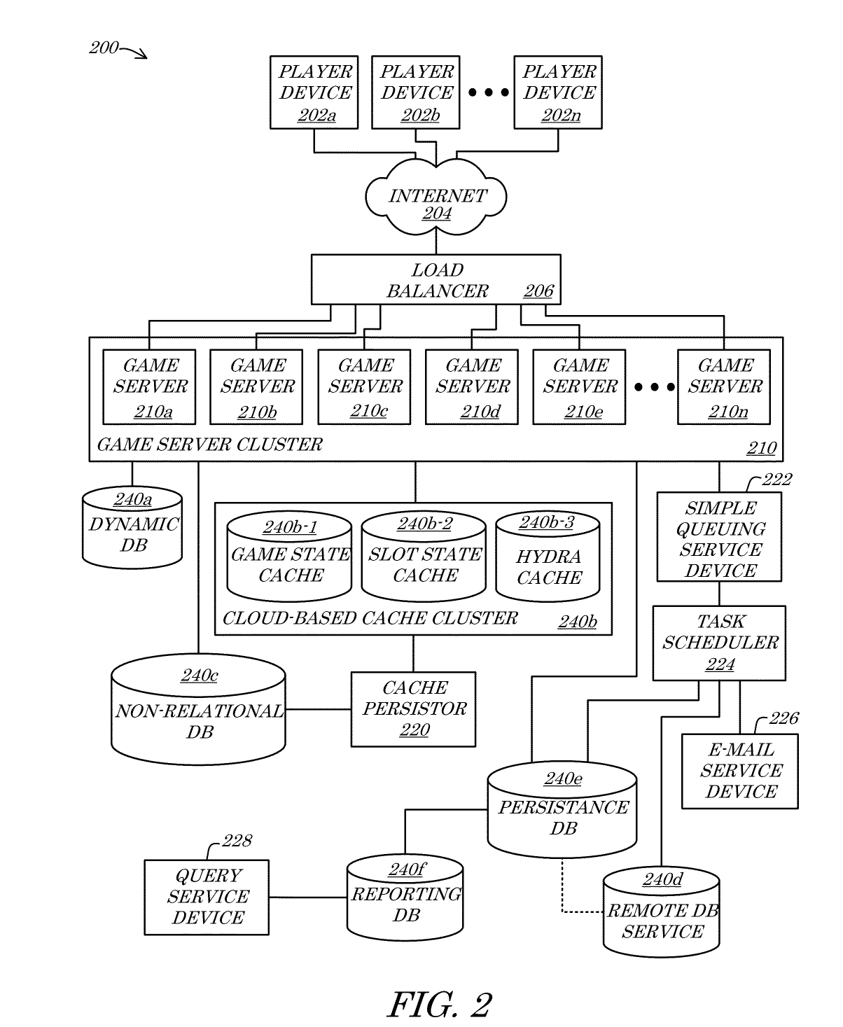

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online game consistent with embodiments described herein, a second game server 210c may host a second particular instance of an online game consistent with embodiments described herein, a third game server 210c may facilitate an online game tournament, and/or a fourth game server 210d may provide an online game in which bonus round enhancers are not usable.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

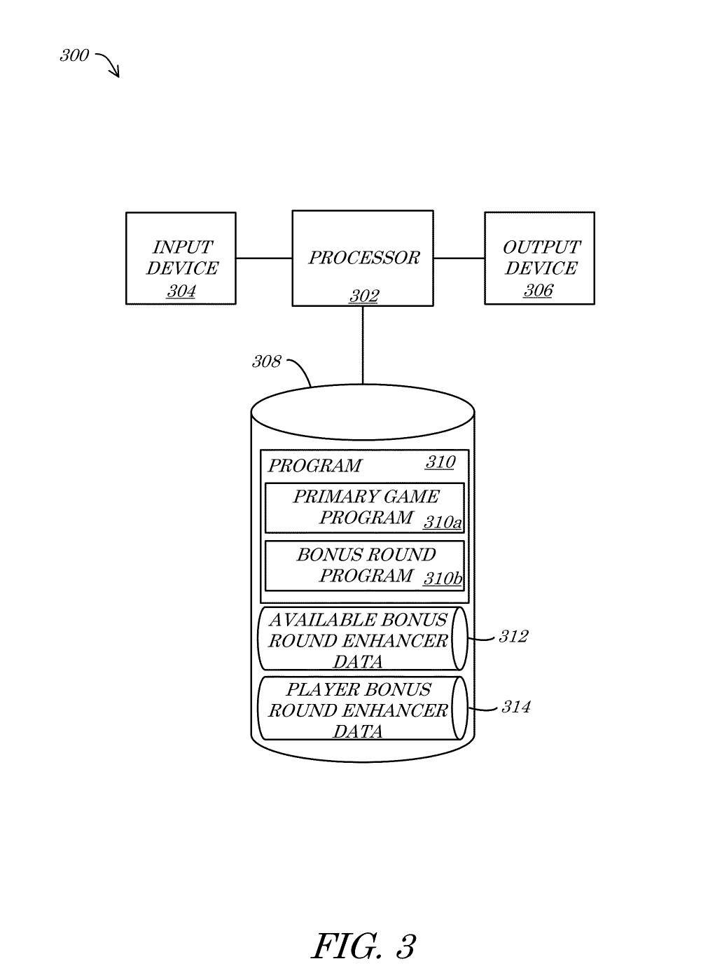

FIG. 3 is a block diagram of an apparatus 300 according to some embodiments. In some embodiments, the apparatus 300 may be similar in configuration and/or functionality to any of the player devices 102, the game server 110 and/or another server device operable to facilitate the embodiments described herein. The apparatus 300 may, for example, execute, process, facilitate, and/or otherwise be associated with any of the processes 700 and/or 800 described herein in conjunction with FIG. 7 and FIG. 8, respectively.

In some embodiments, the apparatus 300 may comprise a processor 302, an input device 304, an output device 306 and/or a memory device 308. Fewer or more components and/or various configurations of the components 302, 304, 306 and/or 308 may be included in the apparatus 300 without deviating from the scope of embodiments described herein.

According to some embodiments, the processor 302 may be or include any type, quantity, and/or configuration of processor that is or becomes known. The processor 302 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 302 (and/or the apparatus 300 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 302 comprises a server such as a blade server, necessary power may be supplied via a standard AC outlet, power strip, surge protector, and/or Uninterruptible Power Supply (UPS) device.

In some embodiments, the input device 304 and/or the output device 306 are communicatively coupled to the processor 302 (e.g., via wired and/or wireless connections and/or pathways) and they may generally comprise any types or configurations of input and output components and/or devices that are or become known, respectively.

The input device 304 may comprise, for example, a keyboard that allows an operator of the apparatus 300 to interface with the apparatus 200 (e.g., by a player, an employee or other worker affiliated with either an online casino or other entity operating a system which provides games to players). In some embodiments, the input device 304 may comprise a mechanism configured to indicate to a remote server device an initiation or triggering of an event instance (e.g., that a player has actuated a “reel spin” mechanism and thus initiated a new spin of a reels-based game), such information being provided to the apparatus 300 and/or the processor 302. In such embodiments, the input device may comprise a key on a keyboard of the apparatus 300. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a touch-screen, a microphone, an infrared sensor, a sonic ranger, a computer port, a video camera, a motion detector, a digital camera, a network card, a Universal Serial Bus (USB) port, a GPS receiver, a Radio Frequency Identification (RFID) receiver, a RF receiver, a thermometer, a pressure sensor, and a weight scale or mass balance.

The output device 306 may, according to some embodiments, comprise a display screen and/or other practicable output component and/or device that is operable to output information. The output device 306 may, for example, comprise a display screen via which are output outcomes, instructions, guidance, questions or information to a player of a game. For example, the output device may output a game interface for a bonus round which comprises a plurality of player selectable elements, such as the bonus round symbols populated into respective ones of a plurality of symbol positions comprising the game interface, an indication of bonus round enhancers available for use by the player during the bonus round and/or any payouts or other awards won or earned by a player as a result of an outcome of the game (primary or bonus round). Some additional examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, the input device 304 and/or the output device 306 may comprise and/or be embodied in a single device such as a touch-screen display or screen.

In some embodiments, the apparatus 300 may comprise any type or configuration of communication device (not shown) that is or becomes known or practicable. For example, the apparatus 300 may include a communication device such as a Network Interface Card (NIC), a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., an initiation of an event instance) to a server (e.g., game server 110) in communication with a plurality of player devices 102. According to some embodiments, the communication device may also or alternatively be coupled to the processor 302. In some embodiments, the communication device may comprise an IR, RF, Bluetooth™, and/or Wi-Fi® network device coupled to facilitate communications between the processor 202 and another device.

The memory device 308 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 308 may, according to some embodiments, store at least one program 310 for facilitating one or more of the embodiments described herein, which program may include (i) one or more primary game programs 310a, each such primary game program for facilitating a respective primary aspect of a game; and (ii) one or more bonus round program s310b, each such bonus round program for facilitating bonus round corresponding to one of the primary games available via the apparatus 300. In some embodiments, the primary game program(s) 310a and/or the bonus round program(c) 310b may be utilized by the processor 302 to provide output information via the output device 306.

The primary game program 310a may, for example, provide instructions for determining at least one of: (i) an outcome for the primary game responsive to a wager or other input from a player which initiates an event instance of the game (e.g., by requesting a random number from another server or device), (ii) which symbol positions (e.g., reel positions) should be populated with which symbols (e.g., determining whether any bonus round enhancers should be included in an outcome of an event instance of the game and, in some embodiments, which symbol positions the bonus round enhancers should be populated); (iii) whether (and if so by how much) to increase a number of bonus round enhancers associated with a player as a result of the event instance; (iv) increasing the credit balance of the player based on any payouts won as a result of the outcome; and (v) whether a bonus round has been triggered as a result of the game instance. In one embodiment, the primary game program 310 may include an RNG for generating a random number (or instructions for communicating with an RNG run on another device), game logic for determining the outcome based on the randomly generated number, and game assets (e.g., art, sound, etc.) for presenting the determined outcome to a player in an audio-visual manner. In some embodiments, the RNG, game logic, and game assets are contained within a player device (a player device comprising a “thick client” gaming terminal), within systems external to a player device 1a player device comprising a “thin client” gaming terminal), or are distributed therebetween in any suitable manner (a player device comprising an “intermediate client” gaming terminal).

In accordance with some embodiments, a bonus round program 310b may function to (i) generate data for a bonus round such as by determining one or more player selectable elements to populate a bonus round interface with; (ii) determine whether a player has provided an instruction to apply a bonus round enhancer within the current bonus round event; (iii) verify that the bonus round enhancer selected for use by the player may be used, based on one or more use conditions which may be associated therewith; (iv) apply the bonus round enhancer to the current bonus round event; (vi) modify one or more elements of a bonus round and/or one or more attributes of the bonus round by applying the bonus round enhancer selected for use by the player; and (v) determine a result of the bonus round (e.g., based on one or more inputs from the player).

In accordance with some embodiments, the apparatus 300 may function as a computer terminal and/or server of an online casino or other entity operating to provide online games, receive and/or manage information related to online games. In some embodiments, the apparatus 300 may comprise a web server and/or other server device operable to accept wagers and determine random numbers based upon which outcomes for wagering games are determined. In some embodiments, the apparatus 300 may comprise an apparatus that is operable to interact with a player of an online game. In some embodiments, apparatus 300 may comprise a plurality of devices working together to accomplish the functionality described herein with respect to FIG. 3.

Any or all of the exemplary instructions and data types described herein and other practicable types of data may be stored in any number, type, and/or configuration of memory devices that is or becomes known. The memory device 308 may, for example, comprise one or more data tables or files, databases, table spaces, registers, and/or other storage structures. In some embodiments, multiple databases and/or storage structures (and/or multiple memory devices 308) may be utilized to store information associated with the apparatus 300. For example, in some embodiments the apparatus 300 may store at least one of (i) an available bonus round enhancers database 312 (e.g., for storing the different types of bonus round enhancers which may be acquire by a player in one or more qualifying games, including any conditions or restrictions associated with each); and (ii) a player bonus round enhancers database 314 (e.g., for storing the types of bonus round enhancers (and number of each type) available for use for a particular player). According to some embodiments, the memory device 308 may be incorporated into and/or otherwise coupled to the apparatus 300 (e.g., as shown) or may simply be accessible to the apparatus 300 (e.g., externally located and/or situated).

### Example Interfaces

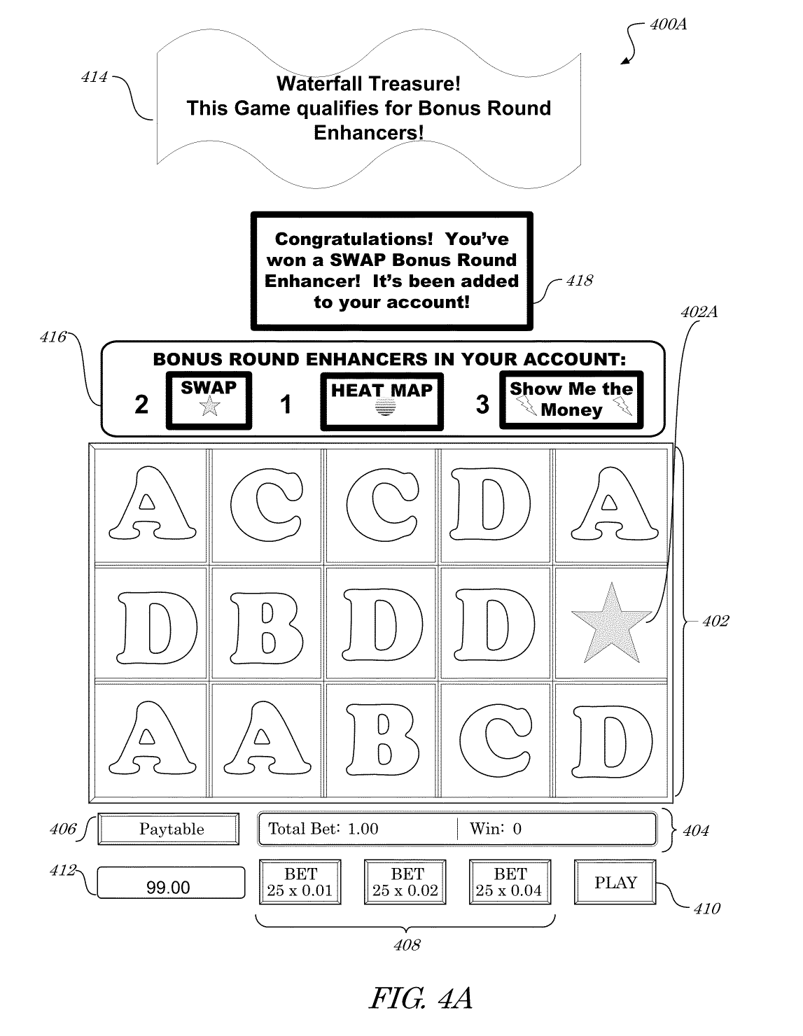

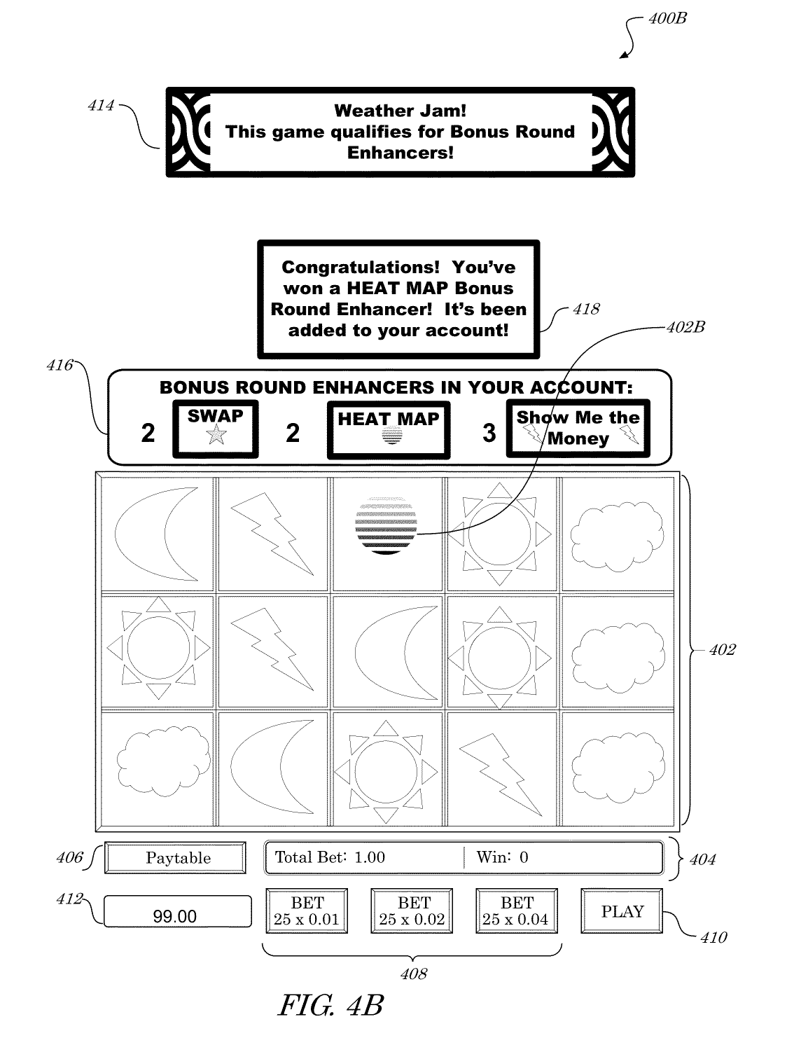

Turning now to FIGS. 4A and 4B, illustrated therein are respective examples of a primary game interface. In particular, each pf FIGS. 4A and 4B illustrates a respective representation of an example primary game interface as it may be output to a player upon a resolution of a spin or other game event, which outputs to the player the symbols comprising the outcome of the game event, including any bonus round enhancers won by the player as a result of the outcome (one manner of acquiring bonus round enhancers, in accordance with some embodiments). FIG. 4A and 4B are each an illustration of a screen shot which represents a “snapshot in time” of a current status of a game event (e.g., the bet placed, the symbols comprising the outcome, any payout won as a result of the outcome), such as it may appear to a player once the reels of the game interface stop spinning, the game event comprising the spin is resolved and the symbols representing the outcome of the game event are output to the player.

The primary game represented in the game interface 400A of FIG. 4A and in the game interface 400B of FIG. 4B, albeit in different primary games, is a reel-based slot machine type game and consists of five vertical reels, with each reel having three symbol positions visible to a player of the game. Thus, the primary games represented in FIGS. 4A and 4B may be thought of as having a 3×5 symbol matrix (3 rows and 5 columns (reels)). Of course any number of reels or number of symbol positions on each reel may be utilized and the embodiments described herein are not dependent on any particular number or configuration of reels or symbol positions in a symbol matrix. Further, as described elsewhere herein, the embodiments described herein are not limited to a reeled slot machine game as the primary game and such is utilized in FIGS. 4A and 4B for illustrative purposes only. Many of the embodiments described herein may be applied to any game interface which includes symbols placed into symbol positions and a determination of whether any of the symbols output in the primary game are special symbols (e.g., bonus round enhancers) which function to modify or enhance a bonus round of a qualifying game. For example, in a multi-hand card game in which a plurality of hands (e.g., a hand being a set of five cards) are arranged in rows of a symbol matrix, one embodiment may comprise outputting in one of the card positions a symbol or card which functions as bonus round enhancer. Other examples of different types of games to which the game mechanics described herein may be applied include, without limitation, bingo and keno.

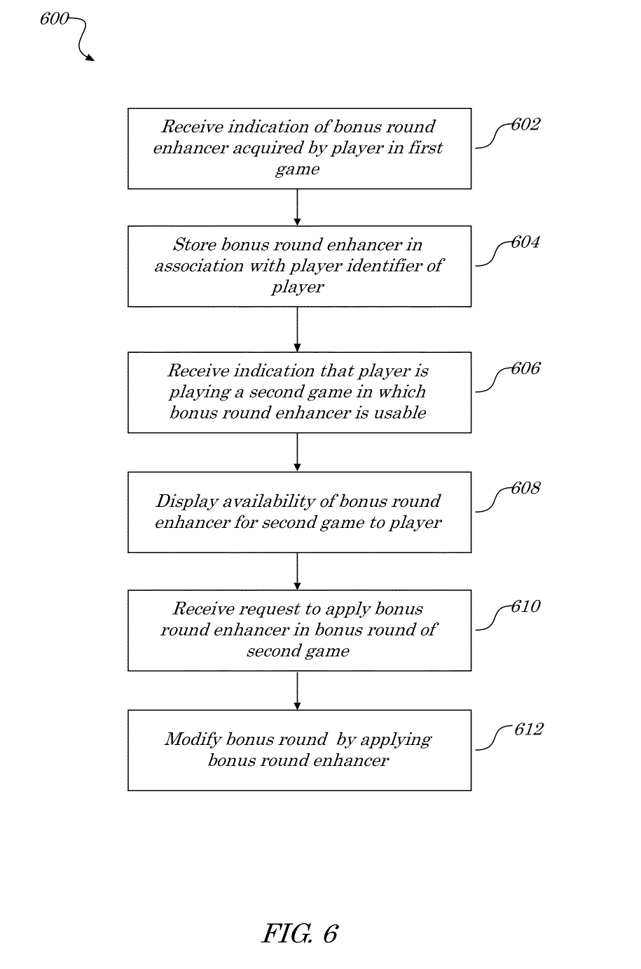

For purposes of describing some embodiments, in the reel game interfaces of FIGS. 4A and 4B, as well as the game interfaces of FIGS. 6A and 6B, the top visible symbol position of a given reel may be referred to as position “0” herein, the middle visible symbol position of a given reel may be referred to as position “1” herein and the bottom visible symbol position may be referred to as position “2” herein. Thus, for example, in FIG. 4A the game symbol “D” positioned in the middle position of the first reel may be referred as being in the “1” position of the first reel and the “SWAP” symbol (a bonus round enhancer, in accordance with some embodiments, positioned in the middle position of the fifth reel may be referred to as being in the “1” position of the fifth reel.

Each of the game interfaces 400A and 400B includes a plurality of areas for outputting information. It should be understood that these areas are merely one example embodiment and any other configuration or design of a primary game interface which allows for the output of bonus round enhancers which may be collected, won or otherwise acquired by a player are within the scope of the invention(s) described herein.

Area 402 comprises an area for outputting a representation of an outcome for the primary game. The example primary game depicted in FIG. 4A is an “A-B-C-D” themed game in which the regular symbols are “A”, “B”, “C” and “D” and one or more bonus round enhancers may be placed in at least one symbol position of the game interface. The example primary game depicted in FIG. 4B is a “weather” themed game in which symbols comprising weather-related symbols (e.g., moon, sun, lightning bolt, and cloud) and one or more bonus round enhancers may be placed in at least one symbol position of the game interface. In some embodiments, bonus round enhancer symbol (i.e., a symbol representing a bonus round enhancer or related functionality) may be placed in a symbol position over or along with a regular symbol, such that (i) the bonus round enhancer symbol is taken into account for purposes of determining how many (and of which type) bonus round enhancer symbols are associated with the player and/or whether a bonus round has been triggered and (ii) the regular symbol may be taken into account in determining whether the player qualifies for a prize as a result of the outcome along a payline of the game interface and/or whether a bonus round has been triggered. In some embodiments, a bonus round enhancer symbol may have dual functionality or effect (e.g., a bonus round enhancer symbol may also function as a wild or scatter symbol). Area 402 comprises a symbol matrix comprising a plurality of symbol positions arranged in a configuration of five (5) columns (e.g., reels) and three (3) rows. Each intersection of a row and column comprises a unique symbol position (e.g., reel position “0” of the first reel on the left is a symbol position which in FIG. 4A has the symbol “A” placed therein while reel symbol position “1” of the first reel on the left is a symbol position which in FIG. 4A has the symbol “D” placed therein).

It should be noted that the symbols to be output in the area 402 for a game event may be determined based on a pseudo-random process. For example, an RNG may be used to determine a random number which may then be used to determine the symbols to output in area 402. The RNG may be stored in, for example, a game server (e.g., game server 110 of FIG. 1), another server device in communication with a player device on which the game is being played or the player device itself. In some embodiments, the initiation of an event instance (e.g., a game event such as an initiation of a spin) or other request for an outcome of the game may cause the player device to request the outcome (or an RNG based upon which an outcome may be determined) from another device such as a game server (e.g., game server 110 of FIG. 1 or a game server 210 of FIG. 2). Thus, in some embodiments when a player places a wager and initiates a game event (e.g., by actuating or selecting the “play” button or area 410), this may cause at least one of a result and an outcome for the game event to be determined. For example, at least one of the following may be determined as a result of a player actuating the “Play” command represented by the area 410: (i) whether a payout for the primary game is to be awarded to the player as a result of the game event; (ii) which symbol of a plurality of available symbols should be placed in each symbol position of the game matrix; (iii) how many (if any) bonus round enhancer symbols are to be awarded to the player as a result of the game event and of which type. Any or all of the foregoing may be determined by at least one of the player device and a remote server device, based on an RNG process or another process.

Area 404 of the screen interface outputs to the player (i) the total bet or wager being placed on the current game event; and (ii) the total win or payout won by the player as a result of the game event. In each of the respective examples of FIGS. 4A and 4B, it is shown that a total bet of 1.00 (e.g., credits, dollars or another currency) has been placed on the current game event and that the player has not won anything as a result of the game event. For purposes of simplicity, it is to be assumed that none of the outcomes illustrated in FIGS. 4A and 4B result in a payout for the primary game being awarded to the player, such that the description may better focus on some example implementations of bonus round enhancers in accordance with some embodiments.

Area 406 of the game interface 400A and the game interface 400B, if actuated or selected by the player, will cause an appropriate paytable and/or other information explaining the rules or mechanics of the game to be displayed to the player (e.g., via a new screen or pop-up window). For example, a selection of area 406 by a player may cause a screen a payout table screen to be output to the player, informing the player of the paylines and payout schedule of the corresponding primary game.

Area 408 includes a selection of different bet amounts which a player may select for a given game event. For example, he player may choose to bet 0.25 (i.e., 25×0.01), 0.50 (i.e., 25×0.02), or 1.00 (i.e., 25×0.04). Of course, additional or different bet amounts may be used and the embodiments described herein are not limited to any particular bet amount or number of bet amounts. In some embodiments, a player may only be eligible to win or collect eliminator symbols by placing at least a minimum wager amount (e.g., by placing the maximum bet amount of the available bet amounts).

Area 412 indicates to the player the current amount of the player's credit balance. In the current examples of FIGS. 4A and 4B, the player has 99.00 credits available for wagering from the credit balance (for purposes of simplicity, the same amount of credits is shown in each of FIGS. 4A and 4B). A bet the player places may be deduced from the credit balance shown in area 412 and any payouts won by the player may be added to the credit balance shown in area 412.

Area 414 comprises an area for outputting the name of the game currently being played (“Waterfall Treasure” in FIG. 4A and “Weather Jam!” in FIG. 4B). Area 416 comprises an area for outputting messages to the player based on current events in the game. In the respective examples of FIGS. 4A and 4B, area 416 is being utilized to output to the player a message informing the player of any bonus round enhancers the player has won as a result of the outcome being output in area 402. Area 418 outputs the type of bonus round enhancers associated with the player, as well as the number of each type of bonus round enhancer. In accordance with some embodiments, a player may acquire (e.g., win, earn or purchase) bonus round enhancers which are usable in a plurality of qualifying games. Thus, the bonus round enhancers illustrated in area 418 of FIG. 4A, for example, may comprise bonus round enhancers associated with the player currently playing the game and which may not necessarily have been earned by the player during play of the current game. For example, when a player initiates play (e.g., initiates a session) of a game in which bonus round enhancers may be utilized during the bonus round stage of the game, a processor facilitating the game (e.g., a processor of apparatus 300) may retrieve from memory any bonus round enhancers previously associated with the player (e.g., bonus round enhancers which the player has previously won, earned, purchased or otherwise acquired). The processor may do so, for example, based on a unique player identifier provided by the player, with which player identifier the bonus round enhancers are associated in a memory (e.g., in a player bonus round enhancer database 314 (FIG. 3). The processor may then cause the output of an indication of the available bonus round enhancers (or otherwise make such information available to the player). During play of a qualifying game, if the player acquires additional bonus round enhancers, the indication of the bonus round enhancers in area 416 may be updated. Additionally, in accordance with some embodiments, the count of how many bonus round enhancers (or of a particular type of bonus round enhancer) may be updated in the memory for subsequent reference. Thus, in accordance with some embodiments, the bonus round enhancers acquired by a player are persistent for the player in the sense that they may be stored in association with a player identifier (or other information unique to the player) such that the player may select the one or more bonus round enhancers so stored in different sessions and in different qualifying games (i.e., the bonus round enhancers, in some embodiments, are not only usable within the game in which they are acquired). Of course, in other embodiments a bonus round enhancer may only be usable by a player in the game in which it was acquired.

In the example illustrated in FIG. 4A, area 418 is being used to output an indication that the player has won one (1) particular type of bonus round enhancer: a “Swap” bonus round enhancer. The area 416 has also been updated to reflect the addition of the newly acquired “Swap” bonus round enhancer. In accordance with some embodiments, the “Swap” bonus round enhancer is represented by a star symbol (of course, any desirable symbol may be used). In accordance with some embodiments, the player currently playing the game has acquired the “Swap” bonus round enhancer as a result of the star symbol being placed in the area 402 upon resolution of a game event (as illustrated in symbol position 402A of area 402).

A “Swap” bonus round enhancer may function to allow a player to swap or trade a current pick (e.g., a most recent player selectable element selected by the player from a pick matrix) for another player selectable element. For example, a “Swap” bonus round enhancer may allow the player to swap a pick just made for one of the neighboring (e.g., adjacent or otherwise within a predetermined distance or geographical relationship to the most recent pick) picks in a pick matrix. In another example, a “Swap” bonus round enhancer may allow a player to swap a current pick for any previous pick. The possible functionalities of a “Swap” bonus round enhancer are provided for illustrative purposes only. The rules or restrictions for using or applying a particular type of bonus round enhancer (such as the particular functionality of a Swap) may be defined in the rules of the game in which the bonus round enhancers are made available.

In the example of FIG. 4B, area 418 is being used to output an indication that the player has won one (1) another particular type of bonus round enhancer (a “Heat Map” bonus round enhancer). The area 416 has also been updated to reflect the addition of the newly acquired “Heat Map” bonus round enhancer. In accordance with some embodiments, the “Heat Map” bonus round enhancer is represented by a striped circle symbol (of course, any desirable symbol may be used). In accordance with some embodiments, the player currently playing the game has acquired the “Heat Map” bonus round enhancer as a result of the striped circle symbol being placed in the area 402 upon resolution of a game event (as illustrated in symbol position 402B of area 402). In accordance with some embodiments, a “Heat Map” bonus round enhancer may function to reveal to the player (in a bonus round comprising a matrix of player selectable elements the values of which are concealed from the player until the player selects at least one of the player selectable elements) information indicative of the relative values of the player selectable elements (e.g., wherein relatively high value player selectable elements are indicated as being “hot”, such as by being shown in red or other indication of high heat, while relatively low value player selectable elements are indicated as being “cold”, such as by being shown in blue or other indication of low or no heat). In some embodiments, such an indication of the relative value of the player selectable elements may be localized or restricted to an area around a particular player selectable element (E.g., a player selectable element the player is prompted to select).

Of course many other types of bonus round enhancers may be utilized and the embodiments described herein are not limited to the types of bonus round enhancers illustrated in FIGS. 4A and 4B. For example, a bonus round enhancer may function to:

(i) guide or advise the player to better (e.g., more valuable) player selectable elements (e.g., reveal or provide a clue or hint to a location of a good or better player selectable element) and/or give the player the option to peek at a value of a number (which may be 1 or greater than 1) of player selectable elements;

(ii) eliminate the player selectable elements having the lowest value(s) from the pick matrix (e.g. which elimination may be localized to an area around a player selectable element the player is prompted to select or has selected);

(iii) eliminate all the player selectable elements having a value lower than the most recently selected player selectable element;

(iv) highlight an area(s) of a pick matrix that contains a player selectable element of special interest or value (this could also be localized to an area around a player selectable element the player is prompted to select or has selected);

(v) allow a “sneak peek” of one or more picks (e.g., temporarily reveal a value of at least one player selectable element available for player selection in a bonus round);

(vi) allow an “undo” of a selection of a player selectable element (e.g., when used, this bonus round enhancer unselects the most recently selected player selectable element);

(vii) indicate a more valuable area, such as a row or column, of a matrix or grid of player selectable elements (e.g., an area which has a greater number of relatively high value player selectable elements or at least one relatively high value player selectable element, as compared to a recently selected player selectable element or as compare to a player selectable element the player is about to select);

(viii) indicate to the player (or automatically select for the player) the player selectable element corresponding to the highest valuable, from a predetermined distance or predetermined positional relationship (e.g., within a specified radius) from the player's most recently selected player selectable element (this type of bonus round enhancer may be referred to as “Show Me the Money”, as illustrated in area 416 of FIG. 4A and 4B);

(ix) allow the next selection to reveal and award to the player not only the value of the player selectable element selected by the player but also reveal and award to the player the respective value of a number of additional of player selectable elements (e.g., a predetermined number of player selectable elements surrounding the player selectable element selected by the player);

(x) cause, after a player selects a symbol location, a reorganization of the concealed values corresponding to the player selectable elements and/or a reorganization of the player selectable elements themselves such that a higher valued player selectable element ends up in the selected symbol location;

(xi) cause an indication, message or warning to be output to the player, informing the player that the selected pick is below an expected value of a pick (or within a predetermined prize range) and gives the option for the player to re-pick;

(xii) reveal to the player the values corresponding to the player selectable elements generated for the bonus round and provide an opportunity to the player to request that a new set of values and/or player selectable elements be generated (e.g., the pick matrix may then be shuffled or regenerated).

In the present application, like reference numerals in the figures refer to like elements. Thus, for example, in the FIGS. 4A and 4B (which show different primary games via which bonus round enhancers may be acquired but which share some common types of areas of a game interface), area 402 is repeated (although it may be shown to output different symbols in the symbol positions of the game matrix, based on an outcome of a spin or replacement of symbols and the theme of the primary game being played). Similarly, areas 404, 406, 408, 410 and 412 are also repeated, although the information or data shown in them may change.

Additional information may be output to the player via the interface illustrated in FIGS. 4A and 4B, which additional information is omitted herein for purposes of brevity. For example, player history or preferences, information about other games the player is participating in, recommendations or tips for betting, etc. may be shown for one or more players.

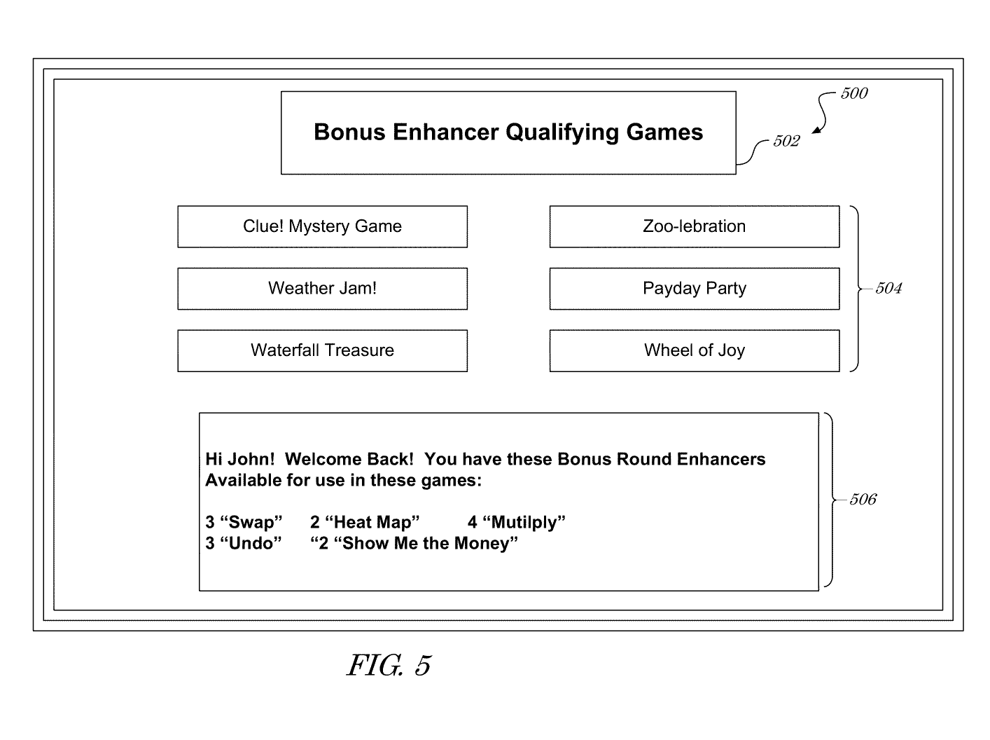

Turning now to FIG. 5, illustrated therein is a representation of an interface 500 which may be output to a player by a game provider or other entity which facilitates the play of one or more games via which bonus round enhancers may be acquired and/or used. The example interface 500 may comprise, for example, a web page of an online game provider or a screen output on a dedicated gaming device (e.g., a screen of a slot machine in a casino). In particular, the interface 500 may be output to a player as a means of informing the player of the different games in which bonus round enhancers may be used and/or acquired. In accordance with some embodiments, a player may acquire one or more bonus round enhancers (whether by winning or earning them in a primary game, purchasing them, or otherwise). The bonus round enhancers acquired by a player may be stored in association with the player (e.g., in a database in which each of the bonus round enhancers acquired by a player is stored in association with the player's player identifier or other data specific to the player such that it may be efficiently retrieved for the player's use). Thus, for example, a player identifier or other data usable for identifying a player and any bonus round enhancers associated with the player may be received from the player before some of the information on the interface is output to the player (e.g., prior to the information in area 506 is output).

The example interface 500 informs a player, in area 502, that the games made available via the interface are ones in which bonus round enhancers may be utilized. The example interface 500 further illustrates in area 504 that there are six (6) different games in which bonus round enhancers may be utilized by a player. Of course, any number of games may be implemented. Area 506 outputs to the player an indication of the types of bonus enhancers available for use by the player, as well as the number of each type of bonus enhancer that is available. The types of bonus round enhancers illustrated in area 506 are non-limiting and provided for illustrative purposes only. In accordance with some embodiments, there may be one or more restrictions or use restrictions associated with one or more bonus round enhancer. Thus, in some embodiments not all bonus round enhancers acquired by a player may be usable in all qualifying games or in all circumstances. In such embodiments, an indication of such restriction(s) or use condition(s) may be output to the player (e.g., in area 506 or via another interface or page).

For example, Table 1 below illustrates an example table comprising player bonus round enhancer data 314, which may store details of the bonus round enhancers available for use by a player, including any use condition(s) associated therewith. In some embodiments, as a player uses a particular bonus round enhancer, a count for that bonus round enhancer may be adjusted in a table, database or other persistent mechanism for storing information about bonus round enhancers associated with a player (e.g., the number of the type of bonus round enhancer selected for use by the player may be decremented by one when a player uses one of that type of bonus round enhancer).

TABLE 1
Player Identifier: P-473-4736362

| Bonus Round | Number | |
|---|---|---|
| Enhancer | Available | Use Condition(s) |
| Swap | 3 | Only usable in games |
| | | G302, G485 and |
| | | G832 |
| Undo | 3 | None |
| Heat Map | 2 | Only usable once per |
| | | hour |
| Multiply | 4 | Not usable with any |
| | | other Bonus Round |
| | | Enhancer; not usable |
| | | in game G475 |
| Show Me the | 2 | Only if player has not |
| Money | | won a prize of at least |
| | | $X value in current |
| | | bonus round |

A player identifier may comprise data which uniquely identifies a particular player or group of players. For example, a player identifier may comprise an identifier generated by and/or assigned to a player by a game provider. In another example, a player identifier may comprise a social security number or a username/password combination which may be provided by a player or assigned to a player. The embodiments described herein are not dependent on any particular type or source of a player identifier. A player identifier may be any data usable to store and retrieve information about bonus round enhancers acquired by the associated player and usable by the associated player in bonus rounds of qualifying games. A player identifier may also be useful in storing and retrieving additional data about a player. For example, a player's name, contact information, wagering history, status, preferences and balance of value usable for making wagers or purchasing bonus round enhancers may also be stored in association with a player's player identifier (e.g., in the same table as data about the player's bonus round enhancers or a different table).

As can be appreciated from a review of the example use conditions illustrated in Table 1, use conditions may vary widely and more than one use condition may be associated with a given bonus round enhancer. In some embodiments, a use condition may be determined for a bonus round enhancer (e.g., at the time the bonus round enhancer is acquired by the player) based on the player identifier or other data associated with the player (e.g., the player's average wager amount or wager amount at the time the bonus round enhancer was acquired, other bonus round enhancers previously acquired by the player, etc.). In some embodiments, different use conditions may be associated with different bonus round enhancers of the same type. For example, a use condition for a particular bonus round enhancer may be based on at least one of the following considerations: (i) whether the bonus round enhancer was acquire in a first game or a second game; (ii) whether the bonus round enhancer was acquire by a player having a first rating or status or by a player having a second rating or status; and (iii) whether the bonus round enhancer was acquired during a special bonus time in which bonus round enhancers are less restricted in their usability.

As described elsewhere herein, bonus round enhancers may be acquired by a player in a variety of manners. The embodiments described herein are not dependent on any particular manner of providing a bonus round enhancer to a player. For example, in one embodiment, prior to the pick bonus type of bonus round beginning, a player may be provided an opportunity to select one or more bonus round enhancers for use in at least one bonus round (in such an embodiment the functions of the bonus round enhancers available for selection to the player may or may not be known to the player before the player selects them). In another embodiment, a player may win one or more bonus round enhancers during play of a primary game or during play of a bonus round. For example, in some embodiments a player selectable element selected by a player in a bonus round may be revealed to be a bonus round enhancer which may be usable by the player later in the bonus round or may be stored for the player for use in another bonus round (of the same game or a different game). In one embodiment, at least one bonus round enhancer may be awarded to or selected by a player in a bonus round stage prior to the actual prize picking stage of the bonus round (e.g., in addition to or in lieu of being awarded or collected during play of the primary game).

In one embodiment, a player may be allowed to acquire a bonus round enhancer by purchasing one using real currency, virtual currency or points usable for such purchase. For example, in one embodiment a player may win or earn such points or virtual currency (e.g., during play of a primary game) and then be able to use such virtual currency or points to acquire one or more bonus round enhancers. In some embodiments, different bonus round enhancers or different types of bonus round enhancers (a type of bonus round enhancer being a bonus round enhancer associated with a particular functionality) may be associated with different values or prices (e.g., the different bonus round enhancers or different types of bonus round enhancers may “cost” different amounts of virtual currency or different number of points). The values of the different bonus round enhancers or different types of bonus round enhancers may, in some embodiments, be proportional to or otherwise based on their potential influence or impact on the result of a bonus round. For example, a bonus round enhancer which reveals the location of the highest valued player selectable element in a pick matrix may be valued higher than a bonus round enhancer which allows a player to undo a most recent selection. Thus, in some embodiments an amount of virtual currency or points usable for purchasing bonus round enhancers may be stored in association with a player and incremented or decremented based on the player's activities.

In some embodiments, a player may need to achieve or maintain a certain minimum wager (e.g., average wager over a predetermined number of game plays) during a primary game in order to qualify to potentially acquire certain bonus round enhancers. In some embodiments, whenever a player wagers the maximum wager he qualifies to potentially win a bonus round enhancer (or points or virtual currency for use in purchasing one or more bonus round enhancers) as part of the result of the game play.

While in some embodiments a bonus round enhancer may be implemented automatically on behalf of a player once it is awarded to the player, in other embodiments a player chooses when or how to utilize a bonus round enhancer (e.g., within the restriction(s) imposed by any use conditions, if any, associated with the bonus round enhancer).

Turning now to FIG. 6, illustrated therein is a flowchart of an example process 600, which is consistent with some embodiments described herein. Process 600 comprises a process for implementing the functionality of at least one bonus round enhancer. The processes 600 may be performed, for example, by at least one of a server device operable to facilitate an electronic (e.g., online) game and/or a player device enabling a player to play the electronic (e.g., online) game. For example, the process 600 may be performed by at least one of (i) a player device 102 (FIG. 1); (ii) a game server 110 (FIG. 1); (iii) a player device 202 (FIG. 2); (iv) a game server 210 (FIG. 2); and (v) apparatus 300 (FIG. 3). Additional and/or different steps may be added to those depicted. Not all steps depicted are necessary to any embodiment described herein. In some embodiments, significant time may pass between the execution of some steps. Process 600 may comprise a subroutine of a more general program. In one embodiment, process 600 may comprise at least a part of bonus round program 310b (FIG. 3). The process 600 is an example processes of how some embodiments described herein may be implemented, and should not be taken in a limiting fashion. A person of ordinary skill in the art, upon contemplation of the embodiments described herein, may make various modifications to process 600 without departing from the spirit and scope of the embodiments in the possession of applicants.

In step 602, it is determined that a player has acquired a bonus round enhancer while playing a first wagering game. In accordance with some embodiments, the bonus round enhancer comprises a game element with an associated functionality which causes a modification of a bonus round once it is applied in the bonus round and the bonus round enhancer may be applied in any of a plurality of qualifying games. Determining that a player has acquired a bonus round enhancer may comprise, for example, determining that the game element comprising the bonus round enhancer is part of an outcome determined for a primary aspect of the first wagering game. For example, a special symbol representing the bonus round enhancer may have been placed in a matrix or other game interface as a symbol comprising the final outcome of a game event in the primary aspect of the first wagering game.

In one embodiment, the at least one device which is executing the process 600 (referred to as the first device in the present description of FIG. 6) determines that the player has acquired the bonus round enhancer by receiving information from another device (referred to as a second device in the present description of FIG. 6). The second device may comprise, for example, a player device on which the player is playing the first wagering game or a game server which determines outcomes for one or more games (such as the primary aspect of the first wagering game) and transmits such outcomes to a player device. In one embodiment, the second device may receive a message from the player device, indicating that a player has acquired a bonus round enhancer. For example, software on the second device may include instructions for outputting a message to the first device upon a player acquiring a bonus round enhancer. In some embodiments, such a message may include at least one of (i) data identifying the player who has acquired the bonus round enhancer; (ii) data identifying the player device via which the bonus round enhancer was acquired; (iii) data identifying the bonus round enhancer or type of bonus round enhancer acquired by the player(e.g., data identifying the corresponding functionality of the bonus round enhancer); (iv) data indicating a time and/or other circumstance within which the bonus round enhancer was acquired; and (v) data indicating at least one use condition associated with the bonus round enhancer or data usable in determining at least one use condition for the bonus round enhancer In some embodiments, the first device may be operable to poll or check with the second device (e.g., periodically) to determine whether any bonus round enhancers have been acquired by players since the last polling and to obtain any information (e.g., such as any of the data in (i)-(v) above) helpful in such a determination.

In step 604, an indication of the bonus round enhancer determined in step 602 is stored in association with a player identifier which uniquely identifies the player. For example, an identifier and/or type of bonus round enhancer may be stored in a record of a database, the record defining the types of bonus round enhancers associated with the player and the number of each type of bonus round enhancers associated with the player. An example of such a record and database is described herein with respect to player bonus round enhancer database 314 and also with respect to Table 1, described with reference to FIG. 5. In one embodiment, each type of bonus round enhancer available for acquisition by a player is associated with a unique bonus round enhancer identifier. In such embodiments, storing an indication of a bonus round enhancer acquired by a player may comprise storing the appropriate bonus round identifier in association with the player identifier (and, for example, a count of how many of each type of bonus round enhancers the player has acquired, which count may be incremented as the player acquires additional bonus round enhancers of the particular type and decremented as the player uses the particular type of bonus round enhancer in a bonus round).

In accordance with some embodiments, one or more use conditions may also be determined and stored in association with the bonus round enhancer acquired by the player. This may be the case if different use conditions may potentially be associated with distinct bonus round enhancers of the same type. In other embodiments in which all bonus round enhancers of the same type are associated with the same use condition(s) (or in embodiments in which there are no use conditions associated with a bonus round enhancer or all types of bonus round enhancers are associated with the same use condition(s), there may not be a need or desire to store any use conditions in association with a bonus round enhancer.

In step 606 it is determined that the player who acquired the bonus round enhancer of steps 602 and 604 has initiated play of a second wagering game in which the bonus round enhancer acquired in the first game may be applied. For example, a second device may communicate with the first device to provide such an indication. Such a communication may comprise, for example, a request to provide an indication of any bonus round enhancers previously acquired by the player which may be usable in a bonus round of the second game. In one embodiment, such a communication may include a player identifier, which identifier may be used to retrieve from memory any bonus round enhancers previously acquired by the player.

In step 608, an indication of an availability of the bonus round enhancer in a bonus round of the second game is displayed to the player (e.g., while the player is playing a primary aspect of the second game or a bonus round of the second game). For example, data may be transmitted to a player device or other second device which allows the second device to display the availability of the bonus round enhancer(s) to the player (e.g., as illustrated in area 416 of FIG. 4A and FIG. 4B). A number of each type of available bonus round enhancers may also be displayed to the player. Any use condition(s) associated with a bonus round enhancer may also be displayed to the player. In one embodiment, if a use condition indicates that a particular bonus round enhancer or particular type of bonus round enhancer is not usable in the second game being played by the player (e.g., at the current time or at any time for the particular game being played), that particular bonus round enhancer or particular type of bonus round enhancer may not be displayed to the player during play of the second game (or may be displayed in greyed-out or other format which indicates the unavailability).

In some embodiments, as illustrated in FIG. 5, an indication of one or more bonus round enhancers previously acquired by the player and available for use by the player may be displayed to the player even when the player is not playing a second game or any game in which any of the bonus round enhancers may be used. For example, a player may be able to pull up an interface (e.g., a web page of an online casino or other game provider) to view the available bonus round enhancers he has acquired. In another example, a listing of the player's available bonus round enhancers may be displayed along with a menu of available games in which at least one of the available bonus round enhancers may be applied (e.g., as is displayed in area 508 of FIG. 5).

In step 610, a request to apply a particular bonus round enhancer associated with the player is received (e.g., from the player via an input device of the player device on which the player is playing the second game). For example, the player may select a particular type of bonus round enhancer from a menu or other listing of available bonus round enhancers displayed to the player during a bonus round of the second game, thus requesting to apply the particular bonus round enhancer. In some embodiments, a particular bonus round enhancer or type of bonus round enhancer which is associated with a player may be highlighted or suggested for use to the player at an opportune time (e.g., if a player selects a low value or negative player selectable element, such as an element which ends the bonus round, an “undo” bonus round enhancer may be highlighted or otherwise suggested for the player's use). In such embodiments, the player agreeing or assenting to the suggestion may be the request to apply the particular bonus round enhancer in the current bonus round.

Of course, as described elsewhere herein, in some embodiments an available bonus round enhancer associated with a player may be applied automatically on behalf of the player even if no request to apply the bonus round enhancer is received from the player. In such embodiments, a bonus round program or other subroutine of a game may be operable to determine when/if an available bonus round enhancer is to be applied. In some embodiments, such selection and application of a bonus round enhancer on behalf of a player may be random.

In step 612, the bonus round enhancer selected for application in the current bonus round is applied. Applying the bonus round enhancer may comprise, for example, determining the functionality corresponding to the bonus round enhancer and implementing the functionality. For example, if the bonus round enhancer is a “Heat Map” type of enhancer, applying the bonus round enhancer may comprise determining the value and placement of each player selectable element in a bonus round matrix and outputting an indication of the relative values to the player (e.g., the player selectable elements corresponding to the highest relative values may be displayed as glowing red, the player selectable elements corresponding to the lowest relative value may be displayed as glowing blue and the player selectable elements corresponding to any mid-values may be displayed as glowing in an orange or yellow color). Any mechanism for indicating the relative values of the player selectable elements, without revealing the actual values, may be utilized so long as the player is informed of the meaning of the indications (e.g., what indications correspond to relatively high values, what indications correspond to relatively low values, etc.).

In some embodiments, applying a functionality of a bonus round enhancer may comprise determining an occurrence of a previous player input, outcome, result or other event in the current bonus round. For example, if an “undo” bonus round enhancer is selected, which allows a player to unselect the most recently selected player selectable element, applying the bonus round enhancer may comprise determining the most recent player selectable element selected by the player.

In some embodiments, applying a functionality of a bonus round enhancer may comprise modifying a value or result previously calculated or implemented in the current bonus round. For example, returning to the “undo” bonus round enhancer, applying the functionality of this bonus round enhancer may comprise undoing whatever occurrence or progress of the bonus round which was caused by the most recently selected player selectable element (e.g., if the most recently selected player selectable element cause a number of credits to be added to a credit balance, applying the bonus round enhancer may comprise subtracting this number of credits from the credit balance).

In some embodiments, applying a functionality of a bonus round enhancer may comprise prompting the player for additional input. For example, in one embodiment a “Swap” bonus round enhancer may correspond to a functionality which allows the player to substitute another player selectable element for a most recently selected player selectable element, applying the functionality may comprise prompting the player to indicate which other player selectable element is to be substituted for the most recently selected player selectable element (in some embodiments, the player selectable element which can be substitute for the most recently selected player selectable element may be restricted to a previously selected player selectable element while in other embodiments other restrictions or no restrictions may be imposed). It should be understood that substituting another player selectable element for a most recently selected player selectable element may comprise substituting the respective values of such player selectable elements.

In some embodiments, applying the functionality of a bonus round enhancer may comprise generating additional data for the current bonus round. For example, if the bonus round enhancer is an “undo” bonus round enhancer, applying the bonus round enhancer may comprise generating or otherwise determining (e.g., requesting from another device) a new player selectable element (and corresponding value) to be placed in the matrix of the bonus round in the position previously occupied by the most recently selected player selectable element. In another example, if a bonus round enhancer corresponds to a functionality which causes a bonus round matrix to be re-ordered (such that player selected elements are re-positioned within the matrix), applying the functionality of the bonus round enhancer may comprise re-ordering the player selectable elements or requesting that a second device re-order the player selectable elements.

In some embodiments, applying the functionality of a bonus round enhancer may comprise determining a location (e.g., in a grid configuration of a bonus round) of at least one player selectable element(s) to be affected by the application of the bonus round enhancer. For example, if the functionality corresponding to the bonus round enhancer comprises selecting and thereby revealing at least one player selectable element in addition to the player selectable element most recently selected by the player which is within a predetermined distance or positional relationship with respect to the most recently selected player selectable element (e.g., all player selectable elements adjacent or within a predetermined radius to the most recently selected player selectable element), applying the functionality may comprise determining which player selectable elements are within such predetermined distance or positional relationship. For example, in one embodiment each player selectable element positioned in a matrix or other interface of a bonus round may be mapped onto the grid or other interface and an indication of the location of each respective player selectable element (e.g., along with its type and/or value) may be stored (e.g., in a database or other memory mechanism accessible to the device performing applying the functionality of the bonus round enhancer). In such an embodiment, applying the functionality of a bonus round enhancer may comprise determining the location, from the memory, of the player selectable element(s) to be selected or otherwise impacted by the application of the functionality.

In some embodiments, applying the functionality of a bonus round enhancer may comprise transmitting an authorization, instruction or signal to a player device, thus causing the player device to apply the functionality locally. In some embodiments, such an authorization, instruction or signal may include an indication of the functionality to be implemented and/or additional data necessary for the player device to apply the functionality. In embodiments in which the functionality of a bonus round enhancer is applied at least in part by a player device or another second device, any of the above-described examples of what applying the functionality may entail may be performed by the player device or other second device.

The management and application of bonus round enhancers may be facilitated by a system such as system 100 (FIG. 1) or system 200 (FIG. 2), or a device included in such a system. For example, at least some processes described herein (such as the example process 600 described with respect to FIG. 6) may be performed by a device such as game server 110 (FIG. 1) or a game server 210 (FIG. 2), such as embodied as apparatus 300 of FIG. 3 in some embodiments. The system or device may be operable to perform one or more processes or subroutines to facilitate (i) the acquisition of one or more bonus round enhancers by a player, (ii) determining whether any use restrictions are to be associated with a bonus round enhancer acquired by a player, (iii) determining that a player is requesting to apply a previously acquired bonus round enhancer, (iv) determining which bonus round enhancers (if any) are available for use by a particular player and/or (v) modifying at least one of a bonus round interface and a result of a bonus round based on an application of a bonus round enhancer. Further, the system or device may be operable to perform at least some of the foregoing for thousands of games simultaneously. For example, the device may be operated by or on behalf of an online game provider and may be operable to facilitate play of qualifying games by thousands of online players, who may be playing a variety of different qualifying games. Thus, a system or device which implements the embodiments described herein is preferably one with sufficient processing power and memory to store bonus round enhancers for thousands of players and be able to determine, simultaneously if necessary for all such players, what particular bonus round enhancers are available for use to those players (e.g., if all such players initiate qualifying games essentially simultaneously, the system or device is preferably capable of determining for each of the players the particular bonus round enhancers previously acquired, and to output an indication of this information to each of the players while they are playing their respective games). The system or device should further be operable to (simultaneously for thousands of players if necessary) process requests from all such players to use a previously acquired bonus round enhancer.

Applicants have recognized that in the competitive business of providing entertaining games, it is challenging to provide game features which distinguish a game providers games from those of other game providers. Applicants have further recognized that today's generation of players would appreciate the ability to save and utilize bonus round enhancers across a plurality of available games and not be constrained to use such bonus round enhancers in only the game in which they are acquired. Applications have also further recognized that providing innovative types of bonus round enhancers in a game may attract and retain players who may otherwise not have been attracted to try the game.

It should be noted that the embodiments described herein are not limited to application in bonus rounds comprising player selectable elements or player selectable elements the values of which are concealed until selected by a player. For example, in one embodiment the embodiments described herein may be applied to a bonus round in which one or more possible bonus round elements are randomly selected for a player once the player enters a bonus round. In another example, one or more bonus round enhancers may be utilized in a bonus round comprising free spins of a reeled slot machine bonus round, wherein an “undo” bonus round enhancer may cause a re-spin of the reels, a “swap” bonus round enhancer may cause a swapping of a symbol in a particular reel symbol position for another symbol (e.g., thus potentially resulting in a winning outcome being generated along a payline), etc.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method of modifying a bonus round of a wagering game, comprising:
storing, on behalf of a player and in association with a player identifier of the player, a plurality of game elements acquired by the player during play of at least one game of a plurality of qualifying games, wherein each game element of the plurality of game elements corresponds to a respective functionality which causes a modification of a bonus round to which it is applied and is associated with at least one use condition;
receiving, from the player, a request to apply one game element of the plurality of game elements in a current bonus round of a game the player is playing, thereby determining a requested game element, wherein the game element had been acquired by the player during play of a first game of the plurality of qualifying games and the current bonus round is a bonus round of a second game of the plurality of qualifying games;
verifying that an application of the requested game element in the current bonus round satisfies at least one of the use conditions associated therewith; and
modifying the current bonus round in accordance with the functionality corresponding to the requested game element.

2. Method of modifying a bonus round of a wagering game, comprising:
determining that a player has acquired a bonus round enhancer while playing a first wagering game, the bonus round enhancer comprising a game element with an associated functionality which causes a modification of a bonus round once it is applied in the bonus round, wherein the bonus round enhancer may be applied in any of a plurality of qualifying games;
storing an indication of the bonus round enhancer in association with a player identifier which uniquely identifies the player;
determining that the player has initiated play of a second wagering game in which the bonus round enhancer acquired in the first game may be applied;
displaying an indication of an availability of the bonus round enhancer to the player while the player is playing a bonus round of the second wagering game;
receiving, from the player, a request to apply the at least one bonus round enhancer in the bonus round of the second wagering game;
applying the functionality of at least one bonus round enhancer to the bonus round by at least one of:
(a) modifying an interface of the bonus round interface in accordance with a functionality of the bonus round enhancer; and
(b) adjusting a result of the bonus round which would have been provided to the player if the bonus round enhancer had not been applied; and
storing an indication of the a use of the at least one bonus round enhancer by the player.

3. The method of claim 2, wherein determining that the player has acquired the at least one bonus round enhancer comprises determining that the player won the at least one bonus round enhancer as a result of an outcome of a primary aspect of the first wagering game.

4. The method of claim 2, wherein determining that the player has acquired the at least one bonus round enhancer comprises determining that the player has purchased the at least one bonus round enhancer using virtual in-game currency.

5. The method of claim 2, further comprising:
determining that the player has acquired the bonus round enhancer while playing the first game comprises determining at least one use condition to be associated with the bonus round enhancer.

6. The method of claim 5, wherein determining at least one use condition comprises determining at least one use condition based on at least one of (i) a characteristic of the first game; (ii) a characteristic of the player; (iii) a characteristic of at least one wager placed by the player; (iii) whether the bonus round enhancer was acquired during a special bonus time.

7. The method of claim 5, further comprising:
determining, upon receiving a request to apply the at least one bonus round enhancer and prior to applying the at least one bonus round enhancer, whether an application of the at least one bonus round enhancer to the bonus round is within the at least one use condition associated with the at least one bonus round enhancer.

8. The method of claim 2, wherein the bonus round comprises a matrix of player selectable elements which the player may select a subset of,
wherein each player selectable element conceals a respective value which is revealed to the player upon a corresponding player selectable element being selected during the bonus round.

9. The method of claim 8, wherein a functionality of the at least one bonus round enhancer allows the player to substitute for a most recently selected player selectable element another player selectable element.

10. The method of claim 9, wherein allowing the player to substitute for a most recently selected player selectable element another player selectable element comprises substituting a value of the most recently selected player selectable element for a value of another player selectable element.

11. The method of claim 8, wherein a functionality of the at least one bonus round enhancer causes an output, in an interface of the bonus round and to the player, an indication of relative values of the player selectable elements not yet selected by the player, without revealing any actual values of any of the player selectable elements.

12. The method of claim 8, wherein a functionality of the at least one bonus round enhancer causes an elimination, from a set of player selectable elements which have not yet been selected in the bonus round, of at least one player selectable element which corresponds to a value which is lower than a value corresponding to a most recently selected player selectable element.

13. The method of claim 8, wherein a functionality of the at least one bonus round enhancer causes an automatic selection on behalf of the player of a player selectable element corresponding to a highest value of available values yet unselected by the player.

14. The method of claim 13, wherein the automatic selection is made from a subset of available player selectable elements, the subset being defined by an area of the matrix relative to the most recently selected player selectable element selected by the player.

15. The method of claim 8, wherein a functionality of the at least one bonus round enhancer causes a predetermined number of player selectable elements to be selected on behalf of the player during the bonus round, in addition to a player selectable elements selected by the player.

16. The method of claim 15, wherein the predetermined number of player selectable elements selected on behalf of the player are selected from a subset of available player selectable elements, the subset being defined by an area of the matrix relative to the most recently selected player selectable element selected by the player.

17. The method of claim 8, wherein a functionality of the at least one bonus round enhancer causes

18. The method of claim 2, further comprising:
display a menu of available games in which the bonus round enhancer acquired in the first wagering game may be applied.

19. A system for promoting game play frequency, the system comprising:
a processor; and
a memory storing instructions, the instructions adapted to execute on the processor to:
store, on behalf of a player and in association with a player identifier of the player, a plurality of game elements acquired by the player during play of at least one game of a plurality of qualifying games, wherein each game element of the plurality of game elements corresponds to a respective functionality which causes a modification of a bonus round to which it is applied and is associated with at least one use condition;
receive, from the player, a request to apply one game element of the plurality of game elements in a current bonus round of a game the player is playing, thereby determining a requested game element, wherein the game element had been acquired by the player during play of a first game of the plurality of qualifying games and the current bonus round is a bonus round of a second game of the plurality of qualifying games;
verify that an application of the requested game element in the current bonus round satisfies at least one of the use conditions associated therewith; and
modify the current bonus round in accordance with the functionality corresponding to the requested game element.

20. A system for promoting game play frequency, the system comprising:
a processor; and
a memory storing instructions, the instructions adapted to execute on the processor to:
store an indication of the bonus round enhancer in association with a player identifier which uniquely identifies the player;
determine that the player has initiated play of a second wagering game in which the bonus round enhancer acquired in the first game may be applied;
display an indication of an availability of the bonus round enhancer to the player while the player is playing a bonus round of the second wagering game;
receive, from the player, a request to apply the at least one bonus round enhancer in the bonus round of the second wagering game;
apply the functionality of at least one bonus round enhancer to the bonus round by at least one of:
(a) modifying an interface of the bonus round interface in accordance with a functionality of the bonus round enhancer; and
(b) adjusting a result of the bonus round which would have been provided to the player if the bonus round enhancer had not been applied; and
store an indication of the a use of the at least one bonus round enhancer by the player.
